(19) United States
(12) Patent Application Publication
(10) Pub. No.: US 2010/0163048 A1
(43) Pub. Date: Jul. 1, 2010

(54) Nose filters

(75) Inventor: Owel Siordia, Sacramento, CA (US)

Correspondence Address: OWEN SIORDIA, 1540 ARCADE BLVD, SACRAMENTO, CA, 95815, US

(73) Assignee: Owel Siordia, Sacramento, CA (US)

(21) Appl. No.: 12/317,790

(22) Filed: Dec. 29, 2008

(51) Int. Cl. A62B 7/10

(52) U.S. Cl. 128/206.11

(57) ABSTRACT

A sponge-type and cone shape invention, acting as particle filters and mounting on the inside of the nose cavity of a person or that of an animal. specially design for people or animals with problems related to airborne particles like dust,pollen and other elements, that can affect the respiratory system negatively, or if used as a two part unit invention to serve the purpose of the use of ointments and other medicated substances. the invention been a sponge type nose filters easy to breath through and easy to discharge.

### CROSS-REFERENCE TO RELATED APPLICATIONS

“not applicable”

### STATEMENT REGARDING FEDERALLY SPONSORED RESEARCH OR DEVELOPMENT

“not applicable”

### REFERENCE TO SEQUENCE LISTING, A TABLE, OR A COMPUTER PROGRAM LISTING COMPACT DISK APPENDIX

“not applicable”

### TECHNICAL FIELD AND BACKGROUND OF THE INVENTION

The present invention relates to a filter-type device call by the inventor nose filters, and is design to be used by people or animals in the nose or nostril cavities to better filter the air intake.

There has been an increasing interest in developing different kind of devices to help people breath better. the main goal of this invention is to help the person or animal breath easier, while at the same time help reduce dust particles and other matter from coming through the nose or nostril cavities.

Considering the negative effects of dust particles and other related airborne spores and particles that affect peoples normal lifestyle, it is the purpose of this invention to eliminate some if not all of this uncomfortable problems by restoring the balance of good breathing and in certain situations help in the aid of restoring a persons or an animals health.

Such filter-type device is consider by the inventor a useful invention to restore a person or animals breathing patter and to aid with certain respiratory problems. also this filter-type device if used with the proper shape and size for the individual needs will reduced the amount of air contaminants that the person or animal breaths in.

### SUMMARY OF THE INVENTION

Therefore it is an object of the invention to provide the person or user with a comfortable device that will help in the breathing process of the person or animal.

A filter-type device with the whole purpose to aid in normal breathing to those whose respiratory system presents them with difficulties under normal circumstances,cause by airborne particles. also to aid those people or animals with permanent breathing conditions and respiratory diseases cause by dust and other particles.

Also to aid on a normal air intake by means of this invention made in different shapes and sizes to correct air flow without obstruction.

FIG. 4 Is a view of the nose filters on its wider area witch is the area of the invention to be exposed to the elements or air particles.

FIG. 5 Is a front view of the nose filters showing a thinner top part of the area that will adjust properly in to the nose cavity when put in the nose.

FIG. 6 A vertical view of the invention, shown as a two part nose filters.demonstrating its way of assembly. also showing the invention separated along side on its longest dimension.

FIG. 7 A horizontal view of the invention showing two small tabs as reference to the attaching properties. also presenting the invention cut along side its longest dimension.

### BRIEF DESCRIPTION OF THE SEVERAL VIEWS OF THE DRAWINGS

Some of the uses and objectives of the invention have been explained previously in part, other objectives and advantages of the invention will be presented as the description of the drawings are disclosed as follow.

FIG. 1 Show a two piece nose filter in its full version of functionality positioned inside the nose.

FIG. 2 Is a view of the invention on a vertical position, with the wider area on the bottom and the thinner area on the opposite side and showing the thickest side, also seen sideway to expose its cone-like form.

FIG. 3 Is a practical view of the nose filters or invention sideways from its thinnest side, showing the difference between figure two and figure three as far as thickness at different angles.

### DETAILED DESCRIPTION OF THE INVENTION

Considering the drawings and their details, the nose filters are basically two spongy cone shape nose plugs. with or without a sticky additive to capture dust particles, allowing the user to breath better or more comfortable.

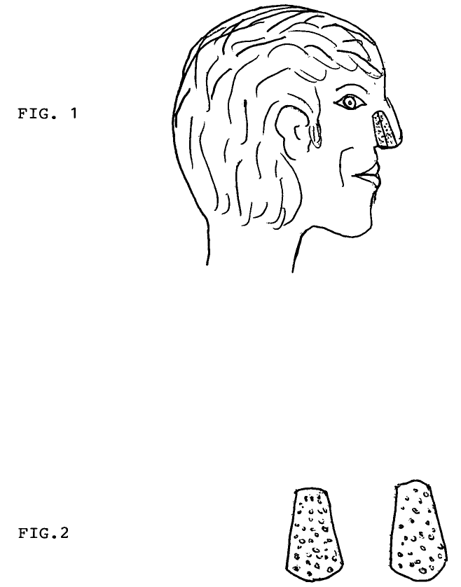

specifically referring to FIG. 1 the nose filters are shown on their full capacity of performance, covering the entrance of the nose and expanding inward for some distance and attaching to the inner walls of the nose creating a seal environment allowing air only to flow through it. performing their main purpose that is to clear air from dust particles and other air traveling elements. also the nose filters are shown here attach inside of the nose with the thicker end towards the front of the nose and the thinner end towards the inside of the nose. also shown in an almost vertical position (drawing of the persons face and head are only for reference purposes).

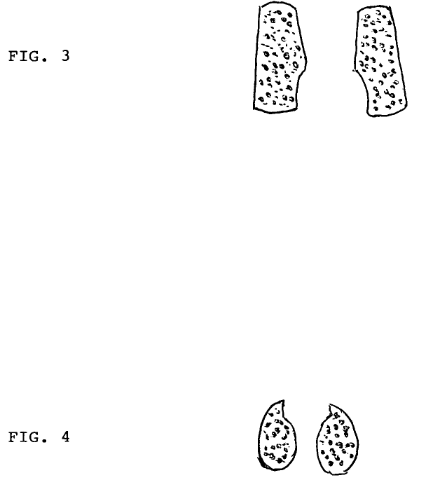

Showing in FIG. 2 is a detailed drawing of the nose filters shown vertically and also revealing its main characteristic of filtration. a sponge-type cone or plug that is to serve the purpose of filtering air intake through the nose.

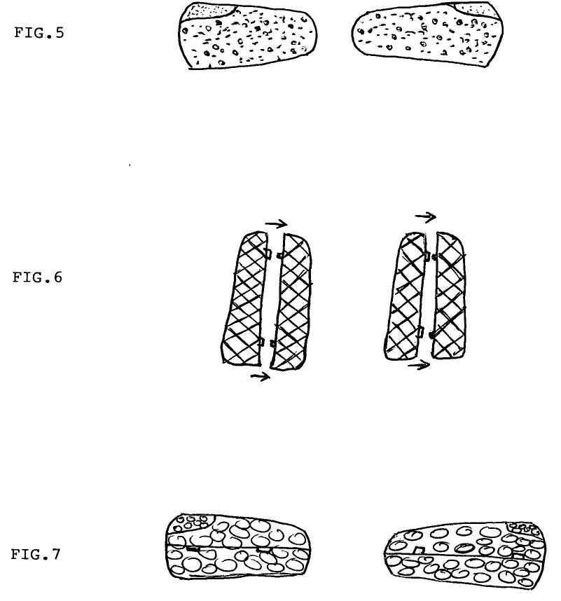

As best shown in FIG. 3 is a side top view of the invention known as nose filters. also shown here is the indentation on the thicker end, this end would be expose to the elements.

FIG. 4 Shows a frontal view of the invention, also showing the properties of filtration or very small holes to let air through. at the same time it exposes a particular shape that most likely would be the shape of the invention on its front end or the side that would be expose to the elements, therefore maintaining this shape would be adequate to seal the nose entrance.

Expose on FIG. 5 is a horizontal view of the invention showing its filtration properties and also exposing the indentation on the thicker end for orientation purposes, this end would be expose to the elements.

FIGS. 6 and 7 are a different approach of the invention to fulfill a different purpose. in this figures the invention is shown vertically and horizontally with its filtration properties. also this figures show the invention separated along side, thus revealing it as a two part invention as well. this figures also show tabs or clips along side to snap the invention together.it also shows that it can be used as a carrying case for a spongy-type nose filter for more specific purposes been this purposes medical or other. also this figures indicate that the invention could have bigger holes or perforations.

What is claim is:

1. A pair of nose filters compose of a breath through spongy material for the purpose of filtering air.with or without a sticky substance to trap dust particles or other airborne elements. each nose filter can also be made of two pieces for special purposes.

2. The nose filters of claim 1 which fits inside the nose cavity.

3. The nose filters of claim 1 which is also secured inside the nose cavity by means of an exact fit of the invention in to the nose.

4. The nose filters according to claim 1 which can be made of different shapes,cone,cylinder,square,etc to better cover the nose cavity letting air flow only through the nose filters.

5. The nose filters of claim 1 also made of a combination of shapes to better fit the nose cavity. the drawings show a cone shape as an example.

6. The nose filters of claim 1 made of solid or flexible materials or a combination of both to create the sponge-type material described on claim 1.

7. The invention of claim 1 made in solid colors or transparent or a combination of colors.

8. The invention of claim 1 combined with different substances to create the sticky properties of the invention that are necessary to trap air particles.

9. The invention of claim 1 also made in different sizes small, medium,large or other to fit every particular need.

10. The invention of claim 1 designated for human use and also for animal use.

11. The invention can also be made as a two part individual filter. made of either flexible or solid materials to act as a carrying case for the sponge-type filter, for special purposes.

12. The invention of claim 11 having holes or perforations of any particular size throughout its embodiment.

13. The invention of claim 11 having at least two snap on tabs or clips but not restricted to a specific number to hold it together as a single unit.

14. The invention of claim 11 with the separation along side its longest perimeter, which would be from front to back of the invention or any other angle chosen to better put the two parts together.

15. The mentioned invention of claim 11 having the locking tabs or clips on the inside,outside,within the embodiment or any other place chosen to hold the two part invention together.
